(19) United States
(12) Patent Application Publication
(10) Pub. No.: US 2008/0151908 A1
(43) Pub. Date: Jun. 26, 2008

(54) METHOD FOR INFORMATION TRANSMISSION WITH BACKBONE NETWORK AND A POSITION MONITORING SYSTEM FOR MULTIPLE ROBOTIC DEVICES

(75) Inventors: Fu-Kuang Yeh, Taoyuan County (TW); Long-Der Chen, Hsinchu City (TW); Chung-Ta King, Hsinchu City (TW); Chun-Han Lin, Taipei County (TW)

Correspondence Address: WPAT, PC, 7225 BEVERLY ST., ANNANDALE, VA, 22003, US

(73) Assignee: INDUSTRIAL TECHNOLOGY RESEARCH INSTITUTE, Hsinchu (TW)

(21) Appl. No.: 11/689,285

(22) Filed: Mar. 21, 2007

(30) Foreign Application Priority Data
Dec. 21, 2006 (TW) 095148192

(51) Int. Cl. H04L 12/56

(52) U.S. Cl. 370/400

(57) ABSTRACT

A method for information transmission with backbone network and a position monitoring system for multiple robotic devices are provided in the present invention, wherein positions of multiple robotic devices disposed and operated in a widespread area are capable of being monitored. The present invention provides a plurality of positioning and transmitting modules for constructing a backbone network for transmitting position information. The positioning and transmitting modules disposed in the positioning area functions to identify the position of robotic device disposed therein and then report the position information to a central managing unit located in the monitoring center through the backbone network. By means of the foregoing method and system, the monitoring center can monitor the position of the plurality of robotic devices and dispatch orders and assign jobs to those robotic devices in a way of distributed and cooperative multitasking.

### FIELD OF THE INVENTION

The present invention relates generally to a method for information transmission and a monitor system and, more specifically, to a method and system in which a backbone network is created for transmitting position information of at least one robotic device in at least one positioning area to a central managing unit so that the central managing unit is capable of managing and monitoring the position of the at least one robotic device dynamically and then dispatches orders and assigns jobs for the at least one robotic device in a way of distributed and cooperative multitasking.

### BACKGROUND OF THE INVENTION

Before a monitoring center dispatching orders in a way of distributed and cooperative multitasking to multiple robotic devices in a wide area for performing jobs such as guard robots patrolling building in the night, or tour-guide robots explaining and guiding for visitors in a museum, it is necessary for the monitoring center to know the location of each robotic device exactly so that the monitoring center is capable of dispatching orders to command the robotic devices to execute their jobs.

Conventional technique, such as U.S. Pat. No. 5,940,346 which is known as “Modular robotic platform with acoustic navigation system”, has disclosed a navigation system and method for identifying a position or navigating an autonomous robotic platform within an area wherein a robotic platform with positioning function is provided so that engineers are capable of utilizing architecture built by such robotic platform for designing robots in demand.

The navigation system and method is provided including a moveable device having an acoustic transmitter for transmitting an acoustic signal, an electronic processor device, an RF receiver and three or more beacons positioned proximate the area. Each beacon including a signal receiving apparatus responsive to the acoustic signal and an RF transmitter. The acoustic signal and the RF signal received from each of the beacons are processed in the electronic processor device to identify the location of the platform within the area. The foregoing navigation system and method, however, is operated only in a smaller positioning area. It could not provide an effective way for widespread area, especially for widespread area having plural robotic devices.

Another conventional way, such as U.S. Pat. No. 6,108,597, discloses an autonomous mobile robot system which is provided with a sensor-based and map-based navigation system for navigating in a pipe network. The navigation is based on the classification of pre-existing natural landmarks. The navigation system can compensate for inaccurate robot system's motion control, sensor information, and landmark classification.

The primary objective of the foregoing technique is not to build exactly positioning system but to control the robot navigating network of sewerage pipes through the sensor-based and map-based navigation system instead. Although the technique discloses a way allowing the robots to know its location so as to execute job autonomously, it does not provide way or method for managing and monitoring multiple robotic devices in a widespread area.

Accordingly, there is a need of a method for information transmission with backbone network and a position monitoring system for multiple robotic devices to solve the problem of the conventional disclosure.

### SUMMARY OF THE INVENTION

A primary objective of the present invention is to provide a method for information transmission with backbone network wherein a link table and a reporting tree are created for constructing a backbone network so as to achieve a purpose of information transmission.

Another primary objective of the present invention is to provide a method for information transmission with backbone network and a position monitoring system for robotic device wherein a backbone network is constructed in a monitoring area having at least one positioning area, each of which having at least one robotic device, defined therein and position information related to the each robotic device is transmitted to a central managing unit disposed in a monitoring center through the backbone network so that a purpose of managing and monitoring the at least one robotic device dynamically in a widespread area is capable of being achieved.

Another objective of the present invention is to provide a method for information transmission with backbone network and a position monitoring system for robotic device, wherein loading of the information transmission may be reduced through a backbone network constructed in a monitoring area having at least one positioning area, each of which having at least one robotic device, defined therein so as to achieve the purpose of improving system efficiency.

For achieving the foregoing objectives, the present invention discloses a method for information transmission with backbone network comprising steps of: constructing a plurality of communicating nodes in an area; generating, for each of the plurality of communicating nodes, its own link table recording at least one of the communicable communicating node; assigning one of the communicating node to be a central managing unit; and creating a backbone network for information transmission by the central managing unit.

Preferably, the way to generate the link table comprises the steps of: (a) distributing, for each of the plurality of communicating nodes, a confirming message; (b) reporting, for each of the plurality of communicating nodes receiving the confirming message, an acknowledge message to the communicating node distributing the confirming message; and (c) recording the communicating node sending the acknowledge message in its own link table by the communicating node distributing the confirming message. Moreover, it further comprises a step of iterating the step (a) to (c) a number of times so as to confirm the communication between the communicating node and the communicating nodes listed in the link table is normal.

Preferably, creating the backbone network further comprises steps of: the central managing unit generating and transmitting a request message to the communicating nodes listed in its own link table for creating a reporting tree; performing, for each of the communicating nodes receiving the request message, a confirming process and then transmitting the request message to the communicating nodes in its own link table; and iterating the previous step until the communicating nodes completing to transmit the request message to the communicating nodes in its own link table so as to create the backbone network.

Furthermore, the foregoing confirming process comprises steps of: determining, for each of the communicating nodes receiving the request message, if the communicating node transmitting the request message is in its own link table or not; assigning the communicating node transmitting the request message to a father layer, if the communicating node transmitting the request message is in its own link table; and abandoning the request message, if the communicating node transmitting the request message is not in its own link table.

The confirming process further comprises steps of: replying a registering message to the communicating node in the father layer by the communicating node receiving the request message; replying, by the communicating nodes receiving the registering message, to the communicating nodes in its own father layer; and iterating the previous steps until the central managing unit receiving the registering message.

For the objectives described above, the present invention further discloses a method for information transmission with backbone network comprising steps of: creating a monitoring area which has at least one positioning area in which at least one robotic device is capable of being monitored; arranging a plurality of communicating nodes inside the monitoring area; generating, for each of the plurality of communicating nodes, its own link table recording at least one of the communicable communicating node; assigning one of the communicating node to be a central managing unit; creating a backbone network for information transmission by the central managing unit; and reporting, by each of the at least one positioning area, the location of the at least one robotic device to the central managing unit.

For achieving the foregoing objectives, the present invention further provide a position monitoring system for robotic devices comprising: at least one robotic device disposed in at least one positioning area respectively, wherein the robotic device includes a first positioning and transmitting module; a plurality of second positioning and transmitting modules, disposed in a monitoring area that has the at least one positioning area and at least one backbone network for information transmission, wherein the second positioning and transmitting modules, disposed in the positioning area, functions to locate the at least one robotic device therein and to transmit at least one position information related to the at least one robotic device through the backbone network built by the second positioning and transmitting modules; and a central managing unit, functioning to receive the at least one position information from the backbone network so as to monitor the at least one robotic device.

More preferably, the first or second positioning and transmitting module is selected from a group consisting of a supersonic positioning and transmitting module, an electromagnetic wave positioning and transmitting module and a combination thereof.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

The drawings, incorporated into and form a part of the disclosure, illustrate the embodiments and method related to this invention and will assist in explaining the detail of the invention.

FIG. 1A is a flow chart that illustrates the preferred embodiment of the method for information transmission with backbone network in the present invention.

FIG. 1B is a flow chart that illustrates a process for building a link table.

FIG. 1C is a flow chart that illustrates a process for creating an information backbone network.

FIG. 2 is a schematic diagram illustrating the preferred embodiment of a position monitoring system for multiple robotic devices in the present invention.

FIG. 3A is a schematic diagram illustrating positioning a robotic device in a positioning area.

FIG. 3B is a schematic diagram depicting the operating process of the positioning and transmitting module.

FIG. 4 is a schematic diagram depicting the process of creating link table.

FIG. 5 is a schematic diagram depicting the information transmission in the position monitoring system of the present invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

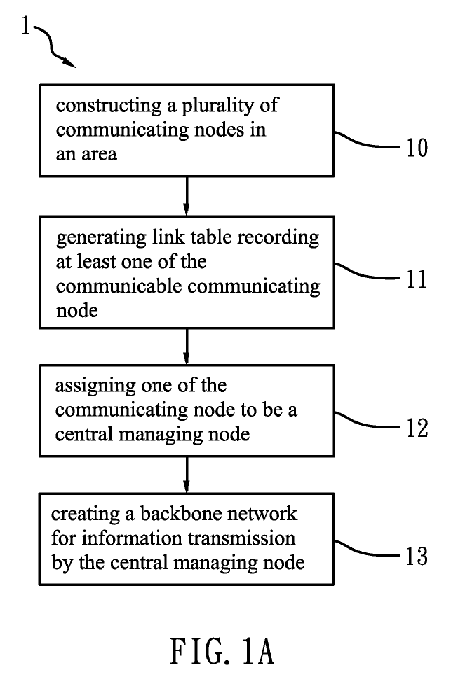

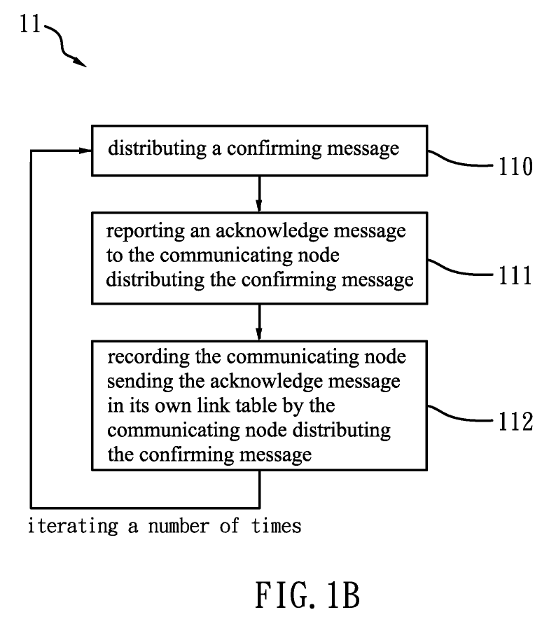

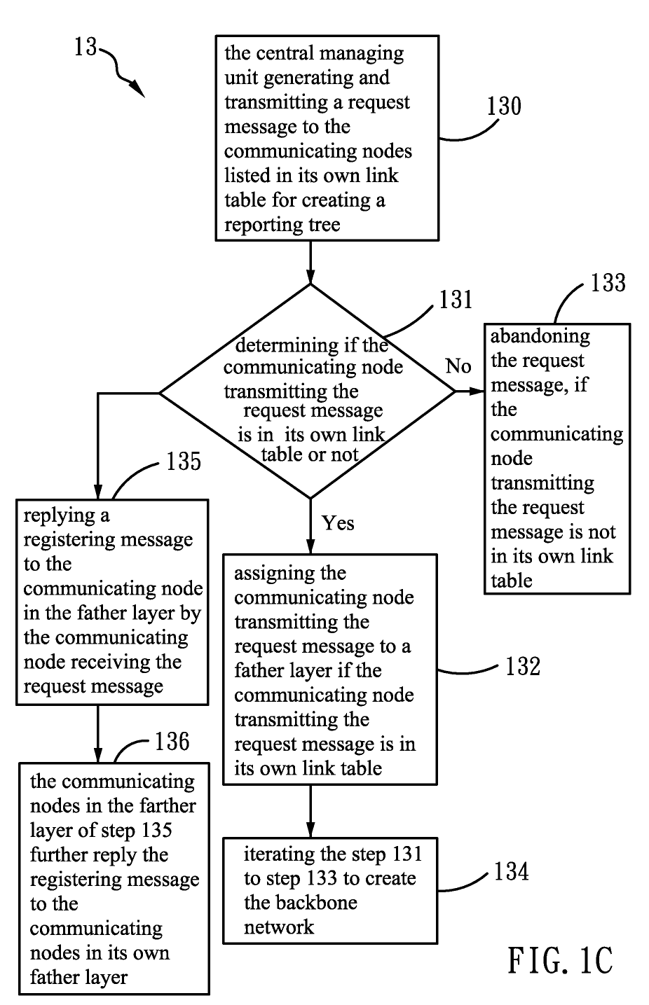

FIG. 1A is a flow chart that illustrates the preferred embodiment of the method for information transmission with backbone network in the present invention. The method for information transmission with backbone network is to create a way for information transmission so as to prevent the system resources and efficiencies from being reduced due to the overloading caused by the massive information transmission. As shown in the FIG. 1A, the method 1 starts from the step 10 to construct a plurality of communicating nodes in an area. Then the step goes to step 11, wherein each of the plurality of communicating nodes generates its own link table recording at least one of the communicable communicating node. By means of the step 11, each communicating node is capable of confirming the other communicating nodes that are available for communication.

Refer to FIG. 1B, which is a flow chart that illustrates a process for building a link table. At first, the step 110 is processed to distribute a confirming message for each of the plurality of communicating nodes. The communicating node is selected to be a supersonic communication module, an electromagnetic communication module or the combination thereof. Next, the process goes to step 111, wherein the communicating nodes receiving the confirming message reply a corresponding acknowledge message to the communicating node distributing the confirming message. After that, step 112 is processed to record the communicating nodes that reply the acknowledge message in the link table by the communicating node distributing the confirming message after receiving the acknowledge message.

Finally, the process iterating the step 110 to step 112 a number of times so as to confirm if the communication between the communicating node and the communicating nodes listed in the link table is normal or not. In this embodiment the times for iterating is 3 times, but should not be a limitation of the present invention. The reason for iterating plural times for communicating confirmation is because the communication status between communicating nodes may be unstable due to some environmental causes. Therefore, through the procedure of iterating confirmation steps, the communication status between communicating nodes is capable of being checked and ensured in a stable situation.

Returning to FIG. 1A, after the step 11, the step 12 is processed to assign one of the communicating nodes to be a central managing unit. Finally, the step 13 is processed to create a backbone network for information transmission by the central managing unit that is the root of the backbone network. Please refer to FIG. 1C, which is a flow chart that illustrates a process for creating an information backbone network. The process 13 for creating the information backbone network is started at step 130, wherein the central managing unit generates and transmits a request message to the communicating nodes listed in its own link table for creating a reporting tree.

After the step 130, the process goes to step 131, wherein each of the communicating nodes receiving the request message performs a confirming process and then transmits the request message to the other communicating nodes in its own link table. The confirming process of step 131 is to determine whether the communicating node transmitting the request message is in the link table, built in the communicating nodes receiving the request message, or not. If yes, then the process goes to step 132 to assign the communicating node, which transmits the request message, to a father layer and then distributing the request message to the communicating nodes in the link table. On the contrary, if not, then the process goes to step 133 to abandon the request message. Thereafter, the step 134 is processed to iterate the step 131 to step 133 until the communicating nodes complete to transmit the request message to the communicating nodes in its own link table so as to create the backbone network.

On the other hand, the step 135 will be processed after step 132, wherein each of the communicating nodes receiving the request message replies a registering message to the communicating node in the father layer. Then the step 136 is processed, wherein the communicating nodes in the farther layer of step 135 receive the registering message and further reply the registering message to the communicating nodes in its own father layer. Then it is iterating the step 136 until the central managing unit receiving the registering message. By means of the step 135 and 136, the central managing unit is capable of managing and monitoring the communication status of the communicating nodes and physical backbone network structure of the reporting tree.

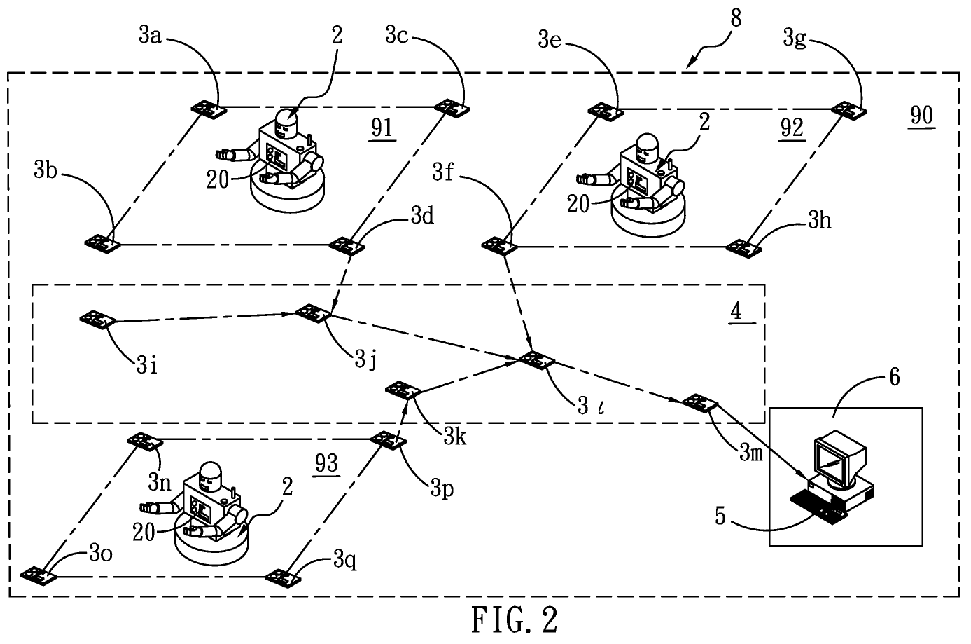

Please refer to FIG. 2, which is a schematic diagram illustrating the preferred embodiment of a position monitoring system for multiple robotic devices in the present invention. The system functions to monitor and transmit the position information related to the multiple robotic devices to a central managing unit disposed in a monitor center through the method disclosed previously. The system is built in a monitoring area 90 having at least one positioning area 91. Each positioning area 91 includes at least one robotic device 2, which has a first positioning and transmitting module 20 disposed thereon. The robotic device 2 may be a robot or a robotic structure combined electrical and mechanical elements that functions to act a specific action such as cleaning and guarding, but the foregoing example should not be a limitation of the present invention.

The monitoring area 90 comprises a plurality of second positioning and transmitting module 3a˜3m. Each of the positioning area 91, 92, and 93 includes the plural second positioning and transmitting modules 3a˜3m that function to form a communicating network inside the positioning area 91, 92, and 93 so as to monitor the at least one robotic device 2 and process and transmit a position information related to the robotic device 2 to the central managing unit. The first and second positioning and transmitting module may be selected to be supersonic communication module, electromagnetic communication module or a combination thereof. In the embodiment, the first and second positioning and transmitting module is a Cricket positioning module, but should not be limited.

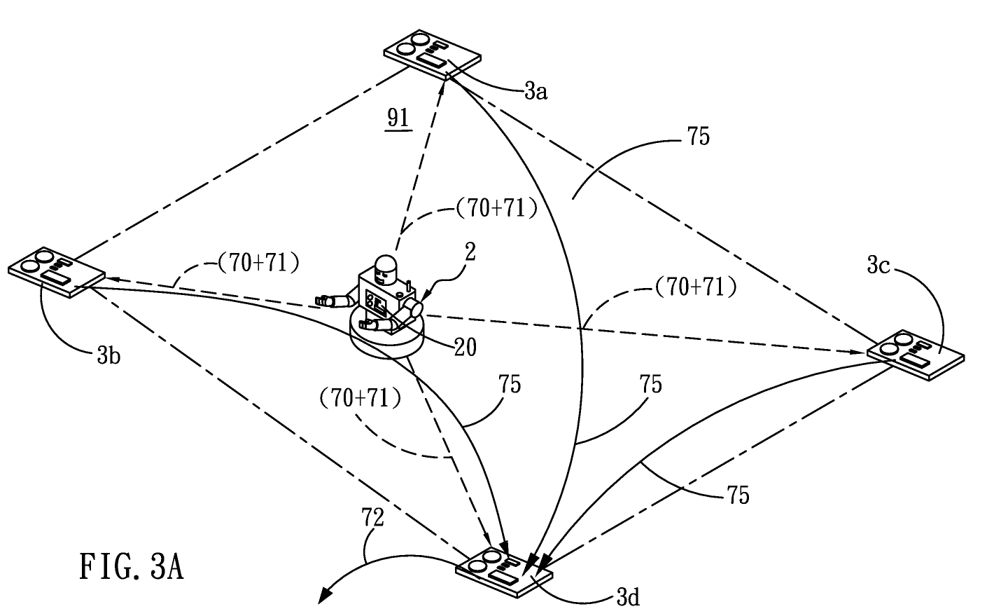

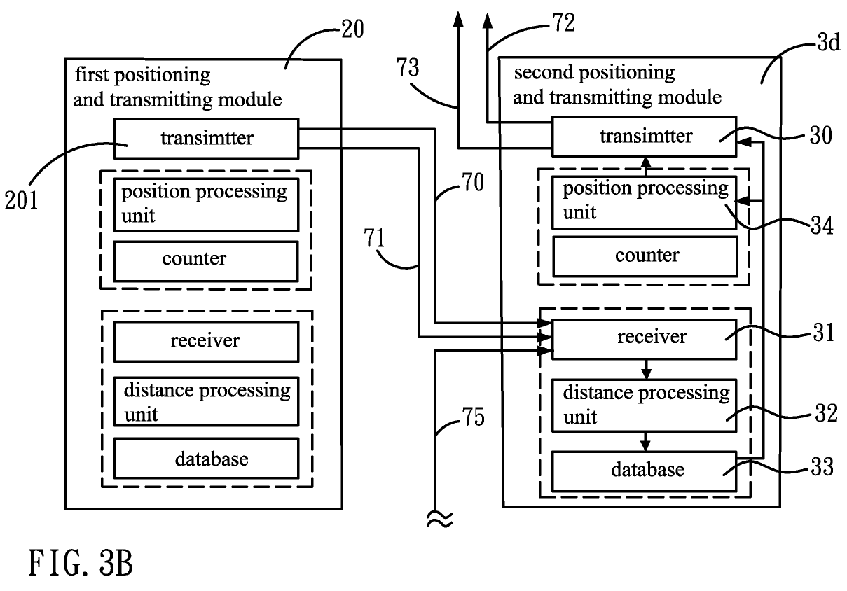

Please refer to FIG. 3A and FIG. 3B, wherein the FIG. 3A is a schematic diagram illustrating positioning a robotic device in a positioning area and FIG. 3B is a schematic diagram depicting the operating process of the positioning and transmitting module. Fundamentally, the positioning and transmitting module, regardless of the first or second positioning and transmitting modules, comprises two procedures including beacon message transmitting procedure and position calculation procedure.

Practically, the operation of the first procedure is described as following (the first and second positioning and transmitting module have the same process):

1. transmitting stage: a period is configured for transmitting the beacon message.
2. transmitting stage: a supersonic signal is transmitted after a first byte of the beacon message is transmitted.
3. receiving stage: waiting and starting to count time required for the arrival of supersonic signal while receiving the first byte of the beacon message.
4. receiving stage: calculating the distance between the transmitter and receiver according to the counted time after the receiver receives the supersonic signal.

The transmitter and receiver in the forgoing 4^{th} stage refers to the first and the second positioning and transmitting module in the present invention. Take the first positioning and transmitting module 20 and the second positioning and transmitting module 3d in FIG. 3A as an example. Please refer to FIG. 3B, the position information transmitting procedure means that the transmitter 201 of the first positioning and transmitting module 20 distributes a beacon message 70 with a supersonic signal 71 periodically (45 ms in this embodiment). While the receiver 31 of the second positioning and transmitting module 3d receives the beacon message 70, the distance processing unit 32 starts to count the time spent on the arrival of the supersonic signal so that a distance between the first and second positioning and transmitting module 20 and 3d is capable of being calculated in the position calculation stage.

After calculating the distance to generate a distance information 73, the second positioning and transmitting module 3d will recode the distance information 73 into a database 33 disposed therein and transmit the distance information 73 to the neighbor positioning and transmitting module such as 3a, 3b, and 3c in FIG. 3A for data exchanging in next beacon time. The other positioning and transmitting module, 3a, 3b, and 3c will also record the distance information 73 into its own database 33. Meanwhile the other positioning and transmitting module, 3a, 3b, and 3c will also perform the same way described above to calculate the related distance with the robotic device in the positioning area 91.

In addition to transmitting distance information 73 in the first procedure, the second positioning and transmitting module 3d will perform position calculation so as to generate a coordinate position related the robotic device in every unit of time. Take the FIG. 3A as an example, the positioning area 91 has four second positioning and transmitting module 3a˜3d, each one will build its own virtual coordinate. By means of the distance information stored in the database, each of the second positioning and transmitting module 3a˜3d can calculate position information of the robotic device and other second positioning and transmitting module with respect to the virtual coordinate respectively.

Therefore in the system of the present embodiment, a virtual coordinate built by one of the second positioning and transmitting module will be picked to be a standard coordinate in the positioning area, i.e. picking up one of the second positioning and transmitting modules to be an origin point of the positioning area. In this embodiment in FIG. 3A, the second positioning and transmitting module 3d is picked to be an origin that receives the distance information related to the robotic device 2 transmitted from the other second positioning and transmitting modules 3a˜3c and stores those information in the database 33, and a position processing unit 34 will generate a coordinate position information about the robotic device 2 according to those distance information.

Returning to FIG. 2, the system further comprises an information transmission backbone network 4 and a central managing unit 5. The information transmission back bone network 4 is formed by the plural second positioning and transmitting modules 3i˜3m, and functions to receive the coordinate position information transmitted from the origin point of the positioning area 91, 92, and 93 to the central managing unit 5. The central managing unit 5, disposed in a monitor center 6, communicates with the information transmission backbone network 4 wirely or wirelessly and is capable of receiving at least one coordinate position information related the robotic devices 2 disposed in the positioning area 91, 92, and 93 so as to monitor and manage the robotic devices 2.

The central managing unit 5 is capable of being a computer, workstation, or server. By means of the method disclosed in FIG. 1A to FIG. 1C and system having an information transmission backbone network formed in a structure of reporting tree in an origin point of the central managing unit 5, the coordinate position information related to the robotic devices 2 may be transmitted to the central managing unit 5 through the information transmission backbone network.

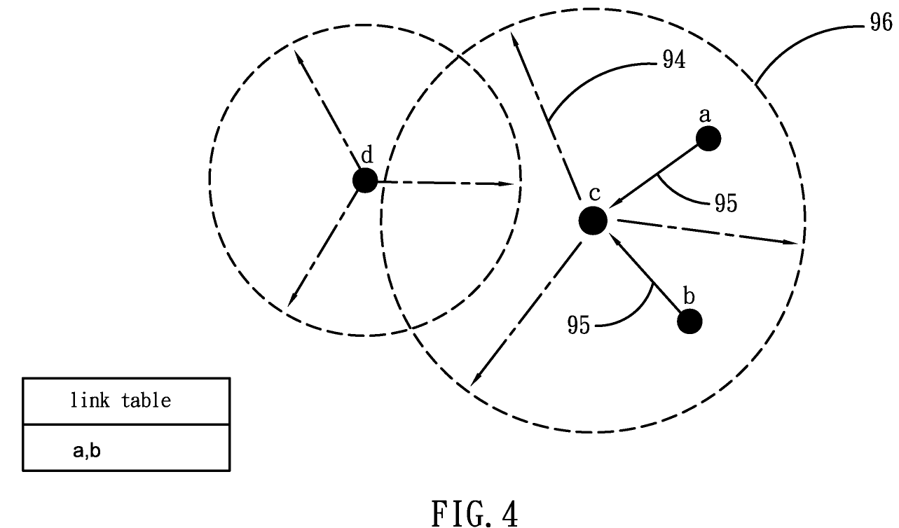

Before building the information backbone network, it is necessary to create a link table for each of the positioning and transmitting module. Please refer to FIG. 4, which is a schematic diagram depicting the process of creating link table. The process building the link table is explained below. Each positioning and transmitting module (including the first and the second positioning and transmitting module), labeled 0 to 4 in FIG. 4, distributes message for building link table periodically. For example, the positioning and transmitting module 0 distributes a confirming message. In case of FIG. 4, the positioning and transmitting 2 and 3 disposed in the communicating range of the positioning and transmitting module 0 reply a acknowledge message respectively to the positioning and transmitting module 0 after receiving the confirming message.

After receiving the acknowledge message from the positioning and transmitting module 2 and 3, the positioning and transmitting module 0 set the positioning and transmitting module 2 and 3 in its own link table. Then it is iterating the previous steps 3 times for ensuring the communication status. In the FIG. 4, the positioning and transmitting module 1 won't be a node in the link table of the positioning and transmitting module 0 because the positioning and transmitting module 1 is not in communicating range of the positioning and transmitting module 0. Finally, with the foregoing steps, each of the positioning and transmitting modules can build its own link table.

Back to FIG. 2, after creating the link table, a reporting tree, taking the central managing unit 5 as an origin, is created to form an information backbone network 4 so that the second positioning and transmitting module 3d, 3f, and 3p, as an origin point of the positioning area 91, 92, and 93 respectively, in the monitoring area can transmit the position information related the robotic device 2 to the central managing unit 5 in the monitoring center 6 through the information backbone network 4. Although the central managing unit 5 is possibly to receive the coordinate position information from the second positioning and transmitting module 3d, 3f, and 3p in each of the positioning area 91, 92, and 93 without creating the information backbone network 4, it will take a lot of system resources, which may be so heavy that causes system failure, to send the position information to the central managing unit 5. In order to avoid transmitting information by using a lot of positioning and transmitting modules, the reporting tree forming the information backbone network 4 described above may be a way to reduce system loading.

In another words, after the reporting tree is formed to build the backbone network in the way shown in FIG. 1C, the positioning and transmitting module only transmits the information to its own father layer, in which the root of the reporting tree is the central managing unit in the monitoring center. Therefore, while there is an updating coordinate position information of the robotic device 2 in one or more positioning area 91, 92, and 93, the root of the positioning area, which is one of the second positioning and transmitting module 3d, 3f, and 3p physically, will distribute the updating coordinate position information to positioning and transmitting module listed in its own farther layer. Finally, the updating coordinate position information will be transmitted to the central managing unit 5 in the monitoring center 6.

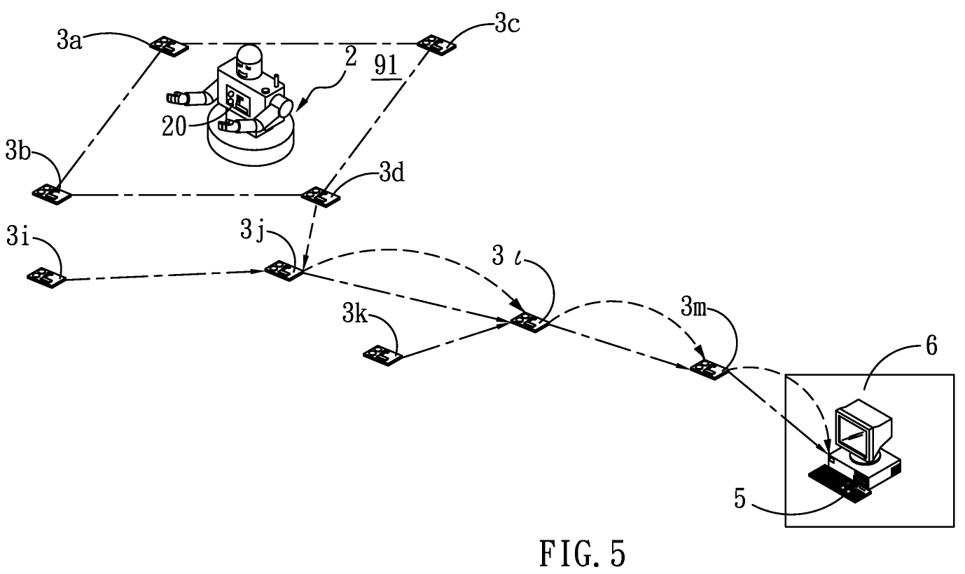

Please refer to FIG. 5, which is a schematic diagram depicting the information transmission in the position monitoring system of the present invention. This figure is helpful to explain the description in the previous paragraph. In the positioning area 91, the second positioning and transmitting module 3d, which is also an origin point of the positioning area 91, calculating the coordinate position related to the robotic device 2. After that, the second positioning module 3d will search the link table to find the positioning and transmitting module 3j belonging to the father layer and then transmit the position information to the positioning and transmitting module 3j. After the positioning and transmitting module 3j receiving the position information, it will also performs the same action to search the link table to find the positioning and transmitting module 31 belonging to the father layer. Iterating the foregoing step, the central managing unit 5 will finally receive the coordinate position information and dispatch the orders or jobs for the robotic device 2 in a way of distributed and cooperative multitasking through the way vice versa.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A method for information transmission with backbone network comprising steps of:
constructing a plurality of communicating nodes in an area;
generating, for each of the plurality of communicating nodes, its own link table recording at least one of the communicable communicating nodes;
assigning one of the communicating nodes to be a central managing unit; and
creating, by the central managing unit, a backbone network for information transmission.

2. The method according to the claim 1, wherein the way to generate the link table further comprises steps of:
(a) distributing, for each of the plurality of communicating nodes, a confirming message;
(b) reporting, for each of the plurality of communicating nodes receiving the confirming message, an acknowledge message to the communicating node distributing the confirming message; and
(c) recording the communicating node sending the acknowledge message in its own link table by the communicating node distributing the confirming message.

3. The method according to the claim 2, further comprising a step of iterating the step (a) to (c) a number of times so as to confirm the communication with the communicating nodes listed in the link table is normal.

4. The method according to the claim 1, wherein creating the backbone network further comprises steps of:
generating and transmitting, by the central managing unit, a request message to the communicating nodes listed in the link table for creating a reporting tree;
performing, for each of the communicating nodes receiving the request message, a confirming process and then transmitting the request message to the communicating nodes in its own link table; and
iterating the previous step until the communicating nodes complete to transmit the request message to the communicating nodes listed in its own link table so as to create the backbone network.

5. The method according to the claim 4, wherein the confirming process further comprises steps of:
determining, for each of the communicating nodes receiving the request message, if the communicating node transmitting the request message is in its own link table or not;
assigning the communicating node transmitting the request message to a father layer, if the communicating node transmitting the request message is in its own link table; and
abandoning the request message, if the communicating node transmits the request message is not in its own link table.

6. The method according to the claim 5, further comprising steps of:
replying a registering message to the communicating node in the father layer by the communicating node receiving the request message;
replying, by the communicating nodes receiving the registering message, to the communicating nodes in its own father layer; and
iterating the previous step until the central managing unit receives the registering message.

7. A method for information transmission with backbone network comprising steps of:
creating a monitoring area which has at least one positioning area in which at least one robotic device is capable of being monitored;
arranging a plurality of communicating nodes inside the monitoring area;
generating, for each of the plurality of communicating nodes, its own link table recording at least one of the communicable communicating nodes;
assigning one of the communicating nodes to be a central managing unit;
creating a backbone network for information transmission by the central managing unit; and
reporting, by each of the at least one positioning area, the location of the at least one robotic device to the central managing unit.

8. The method according to the claim 7, wherein the way to generate the link table comprises steps of:
(a) distributing, for each of the plurality of communicating nodes, a confirming message;
(b) reporting, for each of the plurality of communicating nodes receiving the confirming message, an acknowledge message to the communicating node distributing the confirming message; and
(c) recording the communicating node sending the acknowledge message in its own link table by the communicating node distributing the confirming message.

9. The method according to the claim 8, further comprising a step of iterating a step (a) to (c) a number of times so as to confirm the communication with the communicating nodes listed in the link table is normal.

10. The method according to the claim 7, wherein creating the backbone network further comprises steps of:
generating and transmitting, by the central managing unit, a request message to the communicating nodes listed in the link table for creating a reporting tree;
performing, for each of the communicating nodes receiving the request message, a confirming process and then transmitting the request message to the communicating nodes in its own link table; and
iterating the previous step until the communicating nodes complete to transmit the request message to the communicating nodes in its own link table so as to create the backbone network.

11. The method according to the claim 10, wherein the confirming process further comprises steps of:
determining, for each of the communicating nodes receiving the request message, if the communicating node transmitting the request message is in its own link table or not;
assigning the communicating node transmitting the request message to a father layer, if the communicating node transmitting the request message is in its own link table; and
abandoning the request message, if the communicating node transmits the request message is not in its own link table.

12. The method according to the claim 11, further comprising steps of:
replying a registering message to the communicating node in the father layer by the communicating node receiving the request message;
replying, by the communicating nodes receiving the registering message, to the communicating nodes in its own father layer; and
iterating the previous step until the central managing unit receives the registering message.

13. The method according to the claim 7, wherein the way for reporting the location of the at least one robotic device further comprises steps of:
assigning one of communicating nodes in the positioning area to be a root node; and
reporting, from the root node, the location of the at least one robotic device to the central managing unit through the backbone network.

14. A position monitoring system for robotic devices comprising:
at least one robotic device disposed in at least one positioning area respectively, wherein the robotic device includes a first positioning and transmitting module;
a plurality of second positioning and transmitting modules, disposed in a monitoring area that has the at least one positioning area and at least one backbone network for information transmission, wherein the second positioning and transmitting modules, disposed in the positioning area, functioning to locate the at least one robotic device and to transmit at least one position information related to the at least one robotic device through the backbone network built by the second positioning and transmitting modules; and
a central managing unit, functioning to receive the at least one position information from the backbone network so as to monitor the at least one robotic device.

15. The system according to claim 14, wherein the first positioning and transmitting module is selected from a group consisting of a supersonic positioning and transmitting module, an electromagnetic wave positioning and transmitting module and a combination thereof.

16. The system according to claim 14, wherein the second positioning and transmitting module is selected from a group consisting of a supersonic positioning and transmitting module, an electromagnetic wave positioning and transmitting module and a combination thereof.

17. The system according to claim 14, wherein the central managing unit is selected from a group consisting of a computer, workstation, and server.
